(19) United States
(12) Patent Application Publication
(10) Pub. No.: US 2007/0163432 A1
(43) Pub. Date: Jul. 19, 2007

(54) Method and apparatus for treating a gas stream containing an acid gas

(75) Inventor: Hongqi Yuan, Edmonton (CA)

Correspondence Address: RODMAN RODMAN, 7 SOUTH BROADWAY, WHITE PLAINS, NY, 10601, US

(73) Assignee: ALBERTA RESEARCH COUNCIL INC., Edmonton (CA)

(21) Appl. No.: 11/604,467

(22) Filed: Nov. 27, 2006

Related U.S. Application Data
(63) Continuation-in-part of application No. 11/140,468, filed on May 27, 2005.

(30) Foreign Application Priority Data
May 28, 2005 (CA) 2,470,807

(51) Int. Cl. B01D 46/46

(52) U.S. Cl. 95/1

(57) ABSTRACT

A method for treating a gas stream containing an acid gas, including immersing a permeable membrane having a plurality of pores in an absorption liquid containing a reactant chemical, and passing the gas stream through the pores in the permeable membrane so that the gas stream forms gas bubbles which float up through the absorption liquid and so that the acid gas in the gas stream reacts with the reactant chemical in the absorption liquid, thereby separating the acid gas from the gas stream. A gas absorption apparatus, including a housing adapted to hold an absorption liquid containing a reactant chemical, and a permeable membrane having a plurality of pores contained within the housing and adapted to be immersed in the absorption liquid.

### FIELD OF THE INVENTION

A method and an apparatus for treating a gas stream containing an acid gas.

### BACKGROUND OF THE INVENTION

In a typical chemical absorption reaction, an acid gas is separated from a gas stream by an absorption liquid which contains one or more reactant chemicals. The reaction is then reversed to release the acid gas, so that the reactant chemicals can be reused. One example of a chemical absorption reaction is the reaction of CO₂ gas with an organic solvent such as an aqueous amine. The treatment of CO₂ gas emissions has recently been a focus of attention, in view of global concerns regarding harm to the environment being caused by greenhouse gas emissions.

### SUMMARY OF THE INVENTION

The present invention is a method of treating a gas stream containing an acid gas, comprising providing an absorption liquid containing a reactant chemical and passing gas bubbles of the gas stream through the absorption liquid so that the acid gas in the gas stream reacts with the reactant chemical in the absorption liquid, thereby separating the acid gas from the gas stream.

In one particular method aspect, the invention is a method of treating a gas stream containing an acid gas, comprising: immersing a permeable membrane having a plurality of pores in an absorption liquid containing a reactant chemical, and passing the gas stream through the pores in the permeable membrane so that the gas stream forms gas bubbles which float up through the absorption liquid and so that the acid gas in the gas stream reacts with the reactant chemical in the absorption liquid, thereby separating the acid gas from the gas stream.

In another particular method aspect, the invention is a method of treating a gas stream containing an acid gas, comprising: immersing a permeable membrane module in an absorption liquid containing an inorganic solvent as a reactant chemical, wherein the permeable membrane module is comprised of a plurality of hollow membrane loops each defining a permeable conduit, wherein each of the hollow membrane loops has a plurality of pores, filling the hollow membrane loops with the gas stream so that the gas stream passes through the pores to form gas bubbles which float up through the absorption liquid and so that the acid gas in the gas stream reacts with the reactant chemical in the absorption liquid, thereby separating the acid gas from the gas stream, and regenerating the reactant chemical.

In another particular method aspect, the invention is a method of treating a gas stream containing carbon dioxide, comprising: immersing a permeable membrane module in an absorption liquid containing a reactant chemical comprising an inorganic solvent capable of reacting in a reversible reaction with carbon dioxide, wherein the permeable membrane module is comprised of a plurality of hollow membrane loops each defining a permeable conduit, wherein each of the hollow membrane loops has a plurality of pores, filling the hollow membrane loops with the gas stream so that the gas stream passes through the pores to form gas bubbles which float up through the absorption liquid and so that the carbon dioxide in the gas stream reacts with the reactant chemical in the absorption liquid, thereby separating the carbon dioxide from the gas stream, and regenerating the reactant chemical using a steam regeneration process.

The present invention is also a gas absorption apparatus for use in treating a gas stream containing an acid gas.

In one particular apparatus aspect the invention is a gas absorption apparatus comprised of a housing adapted to hold an absorption liquid containing a reactant chemical. The housing has a gas inlet and a gas outlet. A permeable membrane having a plurality of pores is interposed between the gas inlet and the gas outlet. A gas stream containing an acid gas entering the housing through the gas inlet must pass through the pores in the permeable membrane in order to exit the housing via the gas outlet. The gas stream passes through the pores as gas bubbles which float up through the absorption liquid in order to reach the gas outlet while a reaction occurs between the acid gas in the gas stream and the reactant chemical in the absorption liquid, thereby separating the acid gas from the gas stream.

In another particular apparatus aspect, the invention is a gas absorption apparatus, comprising:
(a) a housing adapted to hold an absorption liquid containing a reactant chemical, the housing having a gas inlet and a gas outlet; and
(b) a permeable membrane contained within the housing and adapted to be immersed in the absorption liquid, the permeable membrane comprising a plurality of hollow membrane loops connected with the gas inlet, each defining a permeable conduit and each having two opposed ends, each of the hollow membrane loops having a plurality of pores interposed between the gas inlet and the gas outlet.

As will hereinafter be further described, inorganic solvents, such as potassium carbonate, have an inherent disadvantage when used in a chemical absorption process in that they provide a slow reaction rate. However, the slow reaction rate can be accommodated by the use of the permeable membrane. Firstly, the gas bubbles produced by passing the gas stream through the pores in the permeable membrane provide a gas-liquid contact area which increases as the size of the pores and the gas bubbles decreases. Secondly, when a permeable membrane is used to pass the gas stream through the absorption liquid, there is greater control over gas and liquid phase pressures and flow rates, which may compensate somewhat for the slower reaction rates associated with inorganic solvents.

The function of the permeable membrane is to facilitate a controlled flow of the gas stream through the permeable membrane such that the gas stream will form gas bubbles as it passes through the permeable membrane. The permeable membrane may therefore be comprised of any structure and/or material which comprises pores which enable the gas stream to pass through the permeable membrane in order to form gas bubbles.

The permeable membrane may therefore be constructed of any natural or synthetic material or combination or materials. The permeable membrane may also be constructed as a solid material with pores or may be constructed of fibers. The permeable membrane may be configured in any manner which facilitates the controlled flow of the gas stream therethrough while causing the production of gas bubbles. The permeable membrane may be configured as a conduit, as a planar membrane, or in any other configuration which enables the permeable membrane to perform its intended functions.

Preferably the permeable membrane is comprised of one or more permeable conduits (i.e., hollow membranes) which include pores in their walls so that the gas stream can be directed through the conduits and pass through the walls of the conduits in order to form gas bubbles which then contact the absorption liquid.

In a non-limiting preferred embodiment, the permeable membrane is comprised of one or more permeable conduits (i.e., hollow membranes) which are constructed from fibers as hollow fiber membranes. The fibers may be comprised of any suitable material, but in the preferred embodiment are comprised of a polymer such as polysulfone or PVDF (polyvinylidene).

In alternate non-limiting embodiments, the permeable membrane may be comprised of one or more permeable conduits (i.e., hollow membranes) which are not constructed as fibers. Such permeable conduits may also be comprised of any suitable material such as, for example, a ceramic material or a metal. Examples of such permeable conduits include permeable ceramic tubes, permeable metal tubes, and sintered metal tubes.

The size of the pores in the permeable membrane is selected to provide a relatively high gas-liquid contact area between the gas bubbles and the absorption liquid while facilitating a suitable flowrate of the gas stream through the permeable membrane at a suitable gas stream pressure with acceptable energy losses.

Preferably the permeable membrane is constructed so that the pores have a “size rating” or “representative size” of between about 0.01 micrometers and about 100 micrometers. More preferably the permeable membrane is constructed so that the pores have a “size rating” or “representative size” of between about 0.1 micrometers and about 10 micrometers.

By size rating or representative size, it is meant that all of the pores in the permeable membrane do not necessarily fall within the prescribed size range, but that the prescribed range reflects an average, median or some other representative measure of the size of the pores in the permeable membrane.

The invention may be defined with reference to the size rating of the pores in the permeable membrane because the size rating of the pores is somewhat determinative of the size rating of the gas bubbles which are produced as the gas stream passes through the pores. However, the invention may also be defined with reference to the size rating of the gas bubbles which contact the absorption liquid.

In this regard, the preferred size rating of the gas bubbles which contact the absorption liquid may be described generally to be of the same order of magnitude as the size rating of the pores in the permeable membrane. For example, the size rating of the gas bubbles may preferably be between about 0.01 micrometers and about 100 micrometers, or more preferably between about 0.1 micrometers and about 10 micrometers.

Alternatively, the size rating of the gas bubbles which contact the absorption liquid may be described generally as the size of gas bubble which is produced under the operating conditions of the invention by pores having a size rating within the range of between about 0.01 micrometers and about 100 micrometers, or more preferably between about 0.1 micrometers and about 10 micrometers.

The gas stream is treated by separating the acid gas from the gas stream. The acid gas is preferably separated from the gas stream by being absorbed by the reactant chemical in the absorption liquid. The acid gas may be comprised of any substance which is an acid or which becomes an acid when placed in an aqueous environment, including but not limited to carbon dioxide (CO₂), hydrogen sulphide (H₂S), sulphur dioxide (SO₂), nitrogen dioxide (NO₂), and combinations thereof.

The reactant chemical may be comprised of any substance or combination of substances which is capable of reacting with the acid gas in order to separate the acid gas from the gas stream, so that the acid gas is effectively absorbed by the absorption liquid. Preferably the reaction between the reactant chemical and the acid gas is reversible.

For example, the reactant chemical may be comprised of an organic solvent or an inorganic solvent. Representative non-limiting examples of organic solvents include amines, and a representative amine solvent is monoethanolamine (MEA). Representative non-limiting examples of inorganic solvents include potassium carbonate, sodium carbonate and aqueous ammonia.

### BRIEF DESCRIPTION OF THE DRAWINGS

These and other features of the invention will become more apparent from the following description in which reference is made to the appended drawings. The drawings are for the purpose of illustration only and are not intended to in any way limit the scope of the invention to the particular embodiment or embodiments shown, wherein:

FIG. 1 is a schematic side elevation view, in section, of a permeable membrane.

FIG. 2 is a side elevation view, in section, of a gas absorption apparatus constructed in accordance with a preferred embodiment of the present invention.

FIG. 3 is a detailed side elevation view, in section, of a hollow membrane module from the gas absorption apparatus illustrated in FIG. 2.

FIG. 4 is a side elevation view, in section, of the gas absorption apparatus illustrated in FIG. 2, connected with a regeneration apparatus.

FIG. 5 is a side elevation view, in section, of an alternative hollow membrane module.

FIG. 6 is a plan view of a gas absorption apparatus using the hollow membrane module of FIG. 5.

FIG. 7 is a graph of off gas stream flow rate as a function of time at a pressure of 20 psi for a hollow membrane loop comprised of PVDF fibers.

FIG. 8 is a graph of off gas stream flow rate as a function of time for hollow membrane loops comprised of either PVDF fibers or polysulfone fibers.

FIG. 9 is a graph of CO₂ concentration in the off gas stream as a function of time for test Run #1.

FIG. 10 is a graph of off gas stream flow rate as a function of time for test Run #1.

FIG. 11 is a graph comparing CO₂ concentration in the off gas stream as a function of time for test Run #1 and test Run #2.

FIG. 12 is a graph comparing off gas stream flow rate as a function of time for test Run #1 and test Run #2.

FIG. 13 is a graph of CO₂ concentration as a function of time for test Run #3.

FIG. 14 is a graph comparing off gas stream flow rate as a function of time for test Run #1, test Run #2 and test Run #3.

### DETAILED DESCRIPTION

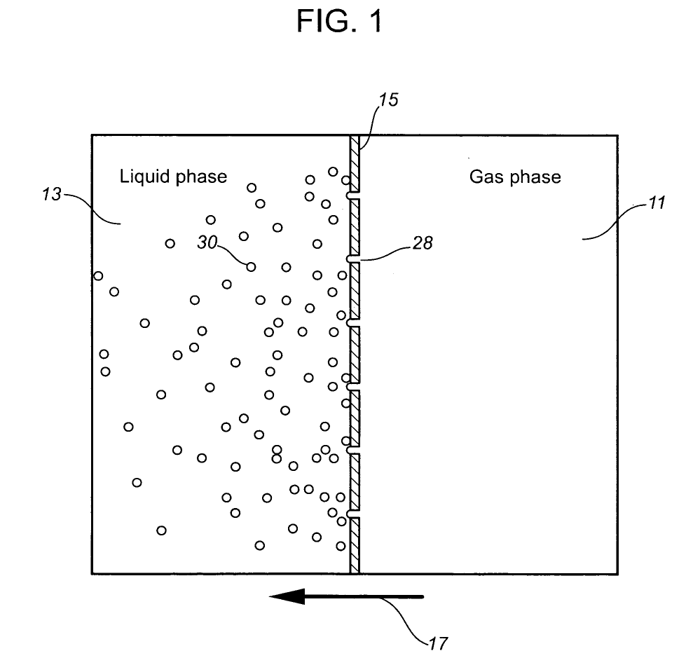

Referring to FIG. 1, the general concept of the operation of a permeable membrane is shown.

There is a gas phase 11 and an absorption liquid phase 13 with a permeable membrane 15 which acts as a barrier to separate the two phases. A pressure difference is applied across permeable membrane 15, where the arrow 17 represents the direction of force caused by the pressure difference. As a result, the gas phase 11, which has a higher pressure, will be pushed across the permeable membrane 15 through the pores 28 in the permeable membrane 15. The resulting gas bubbles 30 will disperse into the absorption liquid phase 13. The size and size distribution of the gas bubbles 30 will depend somewhat upon the size of the pores 28 in the permeable membrane 15. The size and size distribution of the gas bubbles 30 may also depend upon other variables such as, for example, the wetability of the permeable membrane 15, the pressure of the gas stream, and the velocity of the gas stream as it passes through the pores 28.

The concept of generating gas bubbles 30 using a permeable membrane 15 is independent from the configuration of the permeable membrane 15, its manner of construction, or the materials from which it is constructed.

In other words, it doesn't matter if the permeable membrane 15 is a flat sheet or a hollow membrane defining a conduit. As long as the permeable membrane 15 has pores 28 and there is a pressure differential favoring the gas phase 11 side, the gas bubbles 30 will be generated in the absorption liquid phase 13.

In the embodiments described herein, a hollow membrane defining a conduit is used as the permeable membrane 15 as this configuration presents certain advantages which will be apparent from the discussion. However, it will be understood that a flat permeable membrane 15, or any other size and shape of permeable membrane 15, could be substituted without departing from the invention.

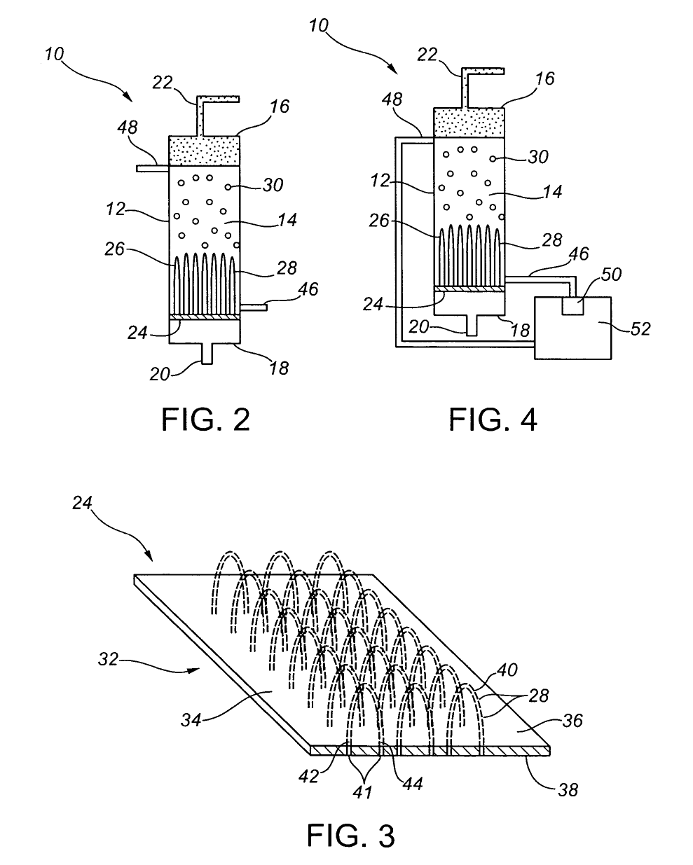

A preferred embodiment of a gas absorption apparatus generally identified by reference numeral 10 will now be described with reference to FIG. 2 through FIG. 6.

Structure and Relationship of Parts:

Referring now to FIG. 2, there is shown a gas absorption apparatus 10. A housing 12 is adapted to hold an absorption liquid 14 containing a reactant chemical. Housing 12 has a top 16 and a bottom 18. There is a gas inlet 20 positioned toward bottom 18 of housing 12, and a gas outlet 22 positioned toward top 16 of housing 12. A permeable membrane 15 functioning as a sparger 24, is positioned between gas inlet 20 and gas outlet 22.

In the preferred embodiment depicted in FIG. 2-6, the sparger 24 is comprised of a hollow membrane 26 defining at least one permeable conduit. More particularly, in the preferred embodiment the hollow membrane 26 is constructed of fibers so that the hollow membrane 26 is comprised of a hollow fiber membrane (i.e., fibers defining at least one permeable conduit).

In the preferred embodiment, the hollow membrane 26 is preferably constructed of polysulfone fibers, and has a plurality of pores 28. The pores 28 are preferably rated at a size of between about 0.01 micrometers and about 100 micrometers. In the preferred embodiment the pores 28 are more preferably rated at a size of between about 0.1 micrometers and about 10 micrometers.

The sparger 24 may, however, be constructed of any material, in any manner of construction, and may have any configuration which enables the sparger 24 to provide a controlled flow rate of the gas stream through the pores 28, thereby producing the gas bubbles 30.

For example, the sparger 24 may be comprised of a permeable conduit constructed from metal, a ceramic material or some other material or combination of materials. Such a sparger 24 may be constructed from fibers or from a solid material and may be configured in a similar manner as depicted in FIG. 2 through FIG. 6. Examples of such a sparger 24 include permeable ceramic tubes, permeable metal tubes and sintered metal tubes.

Sparger 24 is connected to gas inlet 20, such that a gas stream passing through gas inlet 20 enters sparger 24 and then exits the pores 28 as gas bubbles 30 which float up through absorption liquid 14 in order to reach gas outlet 22, while a reaction occurs between the acid gas contained in the gas stream and the reactant chemical in the absorption liquid 14.

Referring now to FIG. 4, housing 12 has a liquid inlet 46 and a liquid outlet 48. Absorption liquid 14 containing the reactant chemical is circulated into the housing 12 through liquid inlet 46 and out of housing 12 through liquid outlet 48. This may be done by a pump 50 or other means of applying a pressure differential. Liquid outlet 48 and liquid inlet 46 are connected to a recovery and regeneration unit 52, such that absorption liquid 14 is continuously drawn from liquid outlet 48 into regeneration unit 52 for regeneration and regenerated absorption liquid 54 is returned to liquid inlet 46.

Referring again to FIG. 3, sparger 24 is in the form of a sparger module 32 which includes a mounting plate 34 and a plurality of hollow membrane loops 40. Mounting plate 34 has a first face 36, a second face 38, and a plurality of openings 41 that extend through mounting plate 34 between first face 36 and second face 38. Hollow membrane loops 40 have opposed ends 42 and 44, each of opposed ends 42 and 44 being in fluid communication with one of the openings 41 on second face 38, such that a gas stream enters openings 41 from first face 36 of mounting plate 34, passes into opposed ends 42 and 44 of the hollow membrane loops 40 as it reaches second face 38 of mounting plate 34, and can only exit the hollow membrane loops 40 by passing through the pores 28.

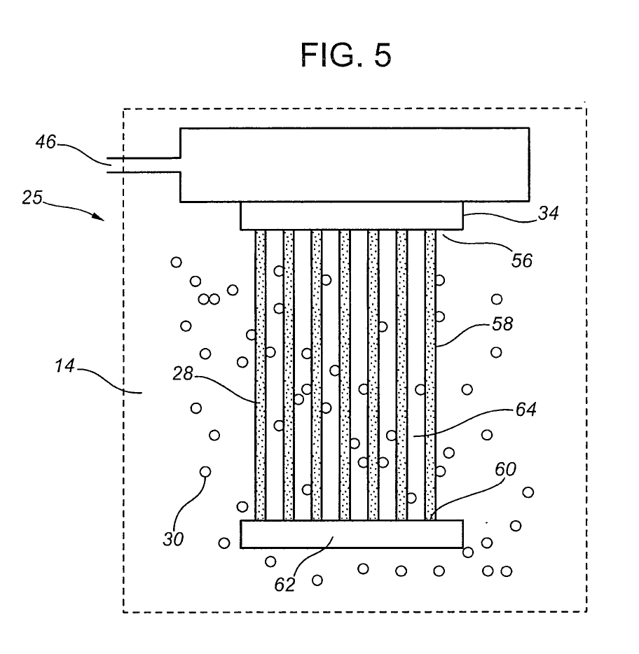

Referring now to FIG. 5, another embodiment of a sparger 25 is shown. In this embodiment, mounting plate 34 is in the form of a manifold which only connects with a first end 56 of hollow fiber membrane lengths 58, which replace the hollow membrane loops 40 in FIG. 3. A second end 60 of length 56 is connected to a sealed block 62. Sealed block 62 may be hollow to allow fluid communication between second ends lengths 58 to help keep the pressure equalized throughout all lengths 58, which together form a bundle 64 or sealed block may block the opposed ends of the hollow fiber membrane lengths 58. As first ends 56 are in fluid communication, communication between the hollow fiber membrane lengths 58 is not required. Gas pressure is applied through gas inlet 46, such that the hollow fiber membrane lengths 58 become pressurized, and the gas stream can only exit through the pores 28 in the form of gas bubbles 30, which gas bubbles pass through absorption liquid 14 as they rise.

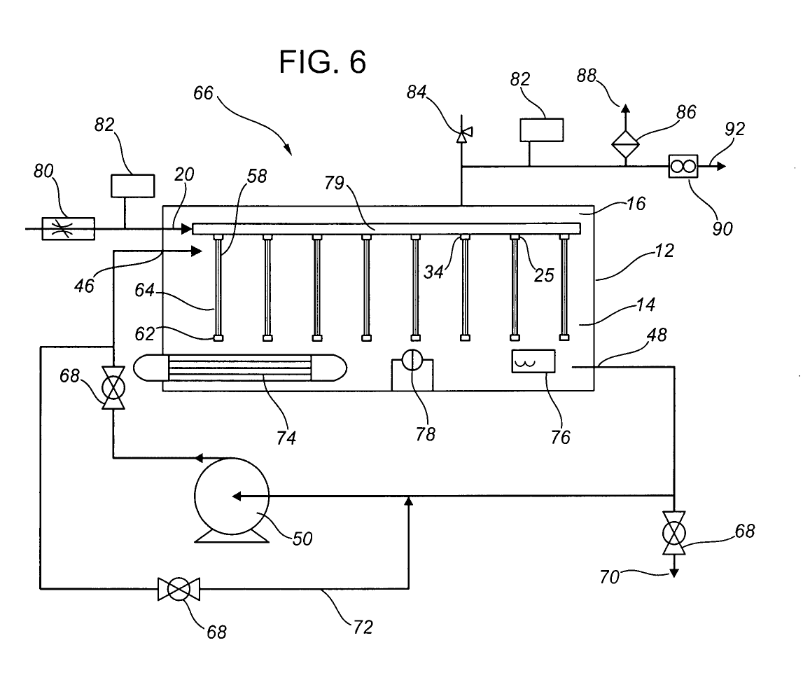

Referring now to FIG. 6, an alternate configuration of a gas absorption apparatus 66 is shown. Absorption liquid 14 circulates though housing 12 by means of pump 50. There are valves 68 which allow a user to send absorption liquid 14 to a drain 70, to turn off the flow of the absorption liquid 14 to housing 12, or to allow flow control through a bypass 72. Inside housing 12 there is a heater 74, a thermocouple 76, and a level switch 78. Heater 74 and thermocouple 76 are spaced apart such that a more accurate reading of the temperature of absorption liquid 14 can be obtained, resulting in better temperature control. Level switch 78 allows the level of absorption liquid 14 in housing 12 to be monitored. A gas stream containing an acid gas enters sparger 25 through gas inlet 20, which is placed closer to top 16 of housing 12 such that gravity pulls sealed block 62 down, thus keeping bundles 64 of the hollow fiber membrane lengths 58 vertical. Multiple spargers 25 are connected to a manifold 79. The flow of the gas stream from a gas source (not shown) to gas inlet 20 is controlled by a flow controller 80 and a pressure transducer 82. Gas outlet 22 is connected to a relief valve 84 with, for example, a 15 psi setpoint. A pressure transducer 82 is also connected to gas outlet 22. A coalescing filter 86 is connected to a sample line 88 to a gas chromatograph to analyze the output gas stream, while a flowmeter 90 measures the flow of the gas stream as it proceeds to a vent 92.

Operation:

The operation of the preferred embodiment will now be discussed with reference to FIGS. 2 to 5. Referring to FIG. 2, the hollow membrane 26 having a plurality of pores 28 is immersed in absorption liquid 14 containing a reactant chemical. The hollow membrane 26 is filled with a gas stream under pressure, which gas stream contains an acid gas. As such, the gas stream passes through the pores 28 to form gas bubbles 30 which float up through the absorption liquid 14 and react with the reactant chemical contained in the absorption liquid 14.

More particularly, the acid gas in the gas stream reacts with the reactant chemical in the absorption liquid 14, thereby separating the acid gas from the gas stream.

As shown in FIG. 3, the hollow membrane 26 is in the form of multiple loops 40 with opposed ends 42 and 44 such that the gas stream is fed into loops 40 from each of the opposed ends 42 and 44. It will be understood that the number of loops will be use-dependent.

The acid gas contained in the gas stream may be any substance which is an acid or which becomes an acid when placed in an aqueous environment, including but not limited to carbon dioxide (CO₂), hydrogen sulphide (H₂S), sulphur dioxide (SO₂), nitrogen dioxide (NO₂), and combinations thereof.

The reactant chemical may be comprised of any substance or combination of substances which is capable of reacting with the acid gas in order to separate the acid gas from the gas stream, so that the acid gas is effectively absorbed by the absorption liquid 14. Preferably the reaction between the reactant chemical and the acid gas is reversible.

As non-limiting examples, the reactant chemical may be comprised of an organic solvent compound or an inorganic solvent compound. Non-limiting examples of organic solvents include amines such as monoethanolamine (MEA) Non-limiting examples of inorganic solvents include potassium carbonate (K₂CO₃), sodium carbonate (Na₂CO₃) and aqueous ammonia.

Referring to FIG. 4, a further step of steam regeneration in the regeneration unit 52 of absorption liquid 14 containing the reactant chemical is used, where absorption liquid 14 is continuously drawn from liquid outlet 48 and returned to liquid inlet 46, in which case the reactant chemical must be capable of reacting in a reversible reaction with the acid gas.

Advantages:

The use of permeable membranes to distribute the gas stream significantly increases the gas-liquid contact area between the gas stream and the absorption liquid, and thus between the acid gas and the reactant chemical.

Capital cost savings may also potentially be realized by using a hollow fiber membrane as the permeable membrane. A hollow fiber membrane is lightweight, compact and flexible and does not corrode.

A permeable membrane can be used to improve the absorption efficiency of existing aqueous amine processes. However, use of a permeable membrane with an inorganic solvent such as potassium carbonate has been found to provide a number of advantages, as compared to aqueous amine processes. The cost of the reactant chemical is lower, lower steam usage is required during regeneration, there is little or no oxidation and degradation of the reactant chemical, and there is relatively lower hydrocarbon solubility.

Information Regarding Properties and Selection of the Hollow Fiber Membrane:

It has been found that an amine based reactant chemical tends to attack a PVDF (polyvinylidene fluoride) fiber in a short period of time, even at ambient temperature and atmospheric pressure.

Therefore, the stability of two polymers, PVDF and polysulfone, in inorganic based solutions was evaluated. The stability tests were conducted by soaking the fibers in a test solution in a glass jar under ambient temperature and elevated temperature. The basic testing solutions were potassium carbonate solution with different concentrations. Piperazine (PZ) was also mixed with potassium carbonate solution, mainly to function as catalyst.

Stability Tests of PVDF Fiber:

The results of the stability tests for PVDF hollow fiber membranes in different potassium carbonate solutions are given in Table 1 below.

TABLE 1
The stability of the PVDF hollow fibre in Potassium carbonated solutions.

| | K₂CO₃ | Piperazine (M) | Temper- | |
|---|---|---|---|---|
| Solution | (M) | (C₄H₁₀N₂) | ature | Observations |
| 1 | 2 | | 25° C. | OK over 6 weeks, |
| | | | | still OK |
| 2 | 2 | 0 | 55° C. | Fiber turns light pink |
| | | | | after 24 hours |
| 3 | 3 | 0 | 55° C. | Fiber turns light pink |
| | | | | after 24 hours |
| 4 | 5 | 0 | 55° C. | Fiber turns pink after 3 |
| | | | | hours |
| 5 | 2 | 0.3 | 55° C. | Fiber turns pink after 1 |
| | | | | hour, |
| | | | | dark |
| | | | | pink after 24 hours |
| 6 | 3 | 0.3 | 55° C. | Fiber turns pink after 1 |
| | | | | hour and |
| | | | | turn brown over |
| | | | | Night |
| 7 | 0 | 0.6 | 55° C. | Pink after I hour, light |
| | | | | brown over night |

For comparison, commercial PVDF flat fiber membranes were also tested under the same conditions. The results indicate that piperazine attacks PVDF fiber at the elevated temperature with or without the potassium carbonate. Potassium carbonate also adds some degree of coloration to the PVDF fiber at elevated temperatures. At room temperature, the PVDF fiber survived. Another observation was that PVDF fiber started changing color where it contacts with air. Oxygen from air has been considered to cause the PVDF fiber to change the color. Therefore, another test was conducted by bubbling the soaking solution with nitrogen to remove oxygen, then soaking the membrane in an oxygen free solution. The results still show that piperazine attacks the PVDF fiber. The commercial PVDF flat fiber membranes also show some coloured spots at elevated temperature.

Based on these tests, it seems feasible to use potassium carbonate solution (2M) and PVDF fiber membranes for absorbing acid gas at room temperature.

Stability Tests of Polysulfone Fiber:

There is no confirmed literature about the stability of polysulfone fiber in potassium carbonate based solutions. The stability tests for polysulfone fibers were also conducted by soaking the polysulfone fibers in four different absorbing solutions in glass vials at room temperatures and at elevated temperatures. Visual observations were recorded at different times.

The results of the stability tests for polysulfone fibers in different potassium carbonate solutions are given in Table 2 below. The note “OK” in Table 2 refers to: no visible color change, and no opacity change of the soaked fiber.

TABLE 2
The stability of the polysulfone fiber in potassium carbonate solutions.

| | | After 24 | After 96 | After 336 | After 432 |
|---|---|---|---|---|---|
| Solution | Temperature | hours | hours | hours | hours |
| 2M K₂CO₃ | Room temp. | OK | OK | OK | OK |
| 2M K₂CO₃ & | Room temp. | OK | OK | OK | OK |
| 0.3M | | | | | |
| PZ | | | | | |
| 2M K₂CO₃ | 50° C. | OK | OK | OK | OK |
| 2M K₂CO₃ | 50° C. | OK | OK | OK | OK |
| & 0.3M | | | | | |
| PZ | | | | | |

In general, the color change indicates some chemical reaction occurring on the polymer surface. The opacity change is an indication of a wetability change. The summary from these tests is that polysulfone fiber does not change significantly in a potassium-based solution at room temperature and at 50 degrees C.

Flow Rate Test Results From PVDF and Polysulfone Fiber:

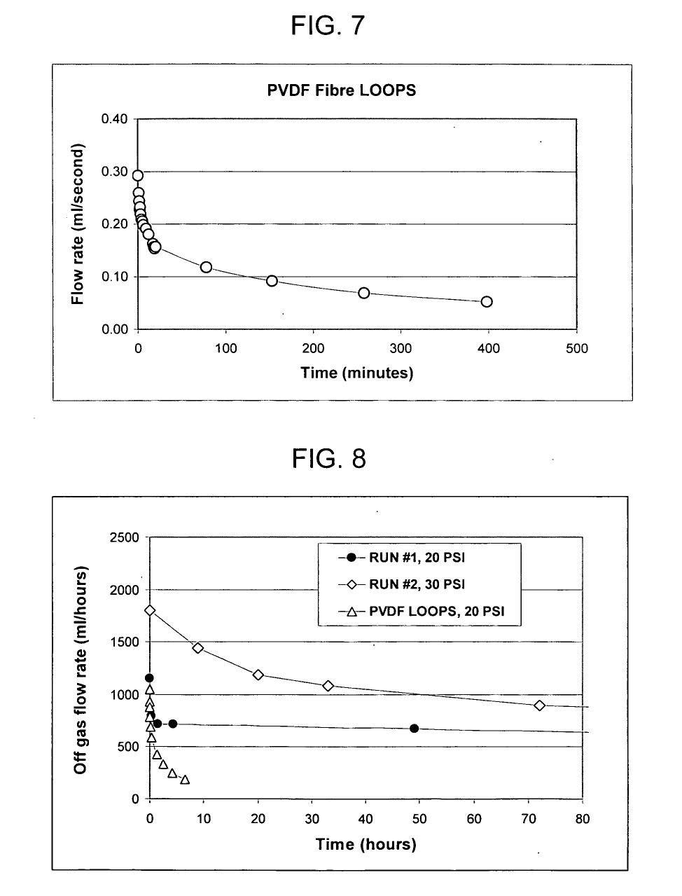

A group of PVDF hollow fiber loops was set up and soaked in 2M potassium carbonate solutions, in a sealed glass cylinder. The inlet gas stream was pressurized through the pores from the fiber wall and was bubbled through the testing solution. The outlet gas stream was connected to a soap bubble flow meter and the off gas flow rates were recorded. The initial inlet gas pressure was 20 psi, and the results are plotted in FIG. 7. There was a continuous drop in the gas stream flow rate at the given pressure which indicated that the pores were plugging. After about 7 hours, the inlet gas stream pressure was increased to 40 psi. There was some gain of the off gas flow rate of the outlet gas stream with the increase of feed gas pressure, but the off gas flow rate dropped to near zero within two and half days.

The similar test of the off gas flow rate from polysulfone fiber loops were also given in FIG. 8. The results indicate that the rate of the drop in off gas flow rate for PVDF fiber is much faster than that for polysulfone fiber. It appears that the phenomenon of off gas flow rate drop is directly related to the plugging of the pores in the fiber wall. The rate of off gas flow rate drop for the polysulfone fiber is initially quite fast at a given pressure. The off gas flow rate can then be keep relatively steady for a period of time, although there is some insignificant drop. The fast initial drop in off gas flow rate appears to be due to the fast plugging of a group of very small pores in the fiber wall.

Based upon the above testing, it was determined that a polysulfone fiber bundle is an acceptable option for use as a permeable membrane in the practice of the invention. Issues relating to the design of a permeable membrane comprising a polysulfone fiber bundle include the following:
1. In order to overcome the hydrophilic nature of the polysulfone fiber, the pressure from the gas phase has to be high enough to balance the capillary pressure from the pores.
2. Conversely, when the pressure goes high enough, gas tends to penetrate the fiber wall through the bigger pores and goes into the liquid phase.
3. As a result, the pore size distribution (i.e., size rating of the pores) in a permeable membrane comprising polysulfone fibers is an important factor for achieving an appropriate gas bubble size and off gas flow rate.
   In addition, the following observations were noted:
1. Polysulfone fiber is not attacked by 2M potassium carbonate solution at room temperature or at elevated temperature (50 degrees C.).
2. Polysulfone is not wet by 2M potassium carbonate solution for longer than 10 days.

The use of polysulfone hollow fiber membranes as the sparger by pressurizing the gas stream through the fiber wall into the liquid phase was chosen for implementation.

Configuration of Permeable Membranes:

A schematic diagram of a sparger unit utilizing polysulfone hollow fiber membranes as the permeable membrane 15 is given in FIG. 2. Referring to FIG. 3, an important component of the sparger unit is the mounting plate 34. The mounting plate 34 is a plastic plate with drilled holes, through which the hollow fiber membranes may be fed as loops and sealed with epoxy. The number of the holes in the mounting plate 34 and the length of the fiber loops is changeable in order to adjust the area of the permeable membrane 15.

The mounting plate 34 is mounted in a plastic cylinder as the housing 12. The cylinder can hold a certain amount of an absorption liquid 14 containing a reactant chemical. The absorption liquid 14 can also be pumped through the cylinder in a controlled flow rate. Because the fiber loops 40 are sealed onto the mounting plate 34, the gas stream can only pass through the pores 28 in the walls of the hollow fiber membranes 40 in order to pass through the absorption liquid 14 in the cylinder toward the gas outlet 22. The off gas obtained at the gas outlet 22 is sent to a gas chromatograph for analysis. The size of the gas bubbles generated from the hollow fiber membranes 40 is directly related to the size of the pores 28 in the walls of the hollow fiber membranes 40.

Experiments consisting of three runs were performed using the parameters described in Table 3.

TABLE 3
Polysulfone hollow fibre sparger tests and some key factors.

| | | Total fibre | Total |
|---|---|---|---|
| Test | Total operation | length | surface area |
| Number | time (hours) | (cm) | (cm²) |
| Run #1 | 213 | 216 | 8.5 |
| Run #2 | 230 | 216 | 8.5 |
| Run #3 | 550 | 600 | 23.6 |

Referring to Table 3, it is noted that Run #2 was performed using the same set of fiber loops 40 as Run #1. However, the mounting plate 34 was removed from the housing 12 after Run #1. The hollow fiber loops 40 were rinsed with water, air dried and then remounted in the mounting plate 34 for Run #2.

The measured factors for Run #1, Run #2 and Run #3 were as follows:

1. total fiber length/membrane 15 surface area

2. total running time.

3. pressure of the gas stream at the gas inlet 20

4. CO₂ content in the gas stream at the gas outlet 22

5. off gas flow rate at the gas outlet 22

6. conversion rate of the reactant chemical in the absorption liquid 14

Summarized Results From Run #1:

The input gas stream was 15% CO₂ and 85% N₂. The absorption liquid 14 contained in the housing 12 contained 2M K.₂CO₃ as the reactant chemical. The pressure of the gas stream at the gas inlet 20 was set at 20 psi (1.36 atm). The CO₂ concentration in the gas stream at the gas outlet 22 was monitored and recorded by a gas chromatograph during the running time. The total running time was 213 hours or about 9 days. Some key operation parameters for Run #1 are provided in Table 4.

TABLE 4
Selected operation factors from test Run #1

| | |
|---|---|
| Operation factors and numbers | Unit |

| | | |
|---|---|---|
| Solution flow rate | 0 | ml/hr |
| Total Solution volume | 750 | ml |
| Solution concentration | 2.0 | M |
| Total moles of K₂ CO₃ | 1.5 | Mole |
| Feed gas CO₂ concentration | 15 | % |
| Feed gas pressure | 20 | psi |
| Average off gas flow rate | 720 | ml/hr |
| Total operation hours | 213.0 | hours |
| Total feed gas volume | 153.4 | Liter |
| Total feed CO₂ | 23.0 | Liter |
| Total fibre length | 216.0 | Cm |
| Total fibre surface area | 8.5 | cm2 |
| Estimated absorbed CO₂ | 1.105 | Mole |
| % of converted K₂CO3 | 73.62 | % |

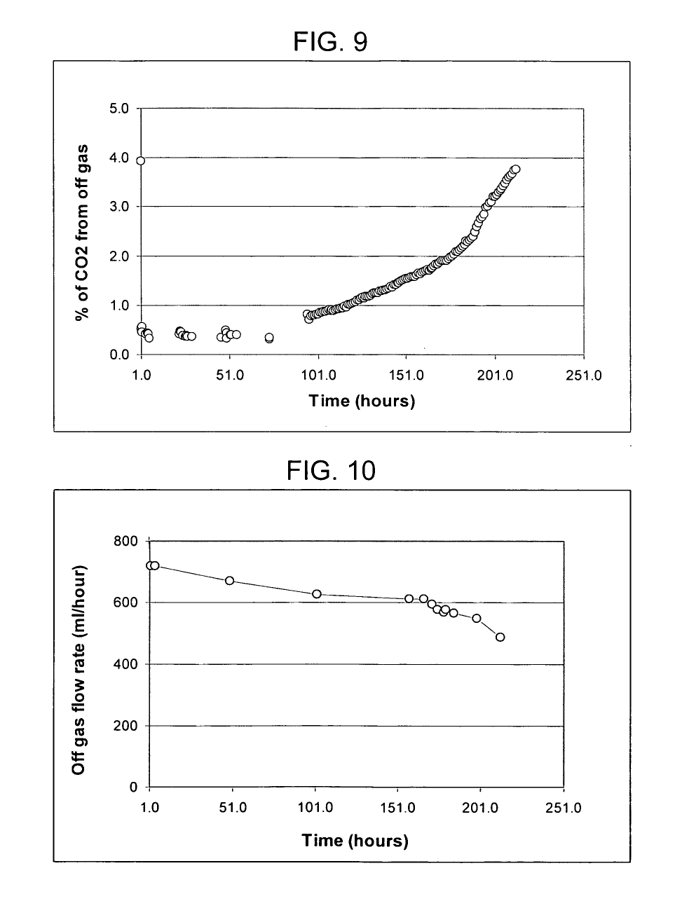

The off gas CO₂ concentration detected by the gas chromatograph during Run #1 is plotted in FIG. 9. The CO₂ concentration in the off gas stream at the gas outlet 22 dropped to 0.4% within one hour. The CO₂ concentration in the off gas stream then began to increase and gradually went up to about 4% by the end of Run #1. The flow rate of the absorption liquid 14 through the cylinder for Run #1 was zero and the total volume of the absorption liquid 14 in the cylinder was 750 mL. A reason that the CO₂ concentration in the off gas stream began to increase during Run #1 could be that the K₂CO₃ solution became saturated.

During the running time of Run #1, the off gas stream flow rate was also measured manually using a soap bubble flow meter. The results are plotted in FIG. 9. The off gas stream flow rate dropped gradually but not significantly from the beginning of Run #1 until about 151 hours, although it dropped more quickly thereafter. During Run #1, the off gas stream flow rate was increased by increasing the pressure of the gas stream at the gas inlet 20. One cause for the drop in the off gas stream flow rate may be the wetting of the pores 28 of the hollow fiber loops 40 by the absorption liquid 14.

After Run #1 was completed, the mounting plate 34 was removed from the cylinder and the fiber loops 40 were rinsed with water and dried overnight. The same set of fiber loops 40 were then re-mounted in the mounting plate for Run #2.

Results and Comparison Between Run #1 and Run #2:

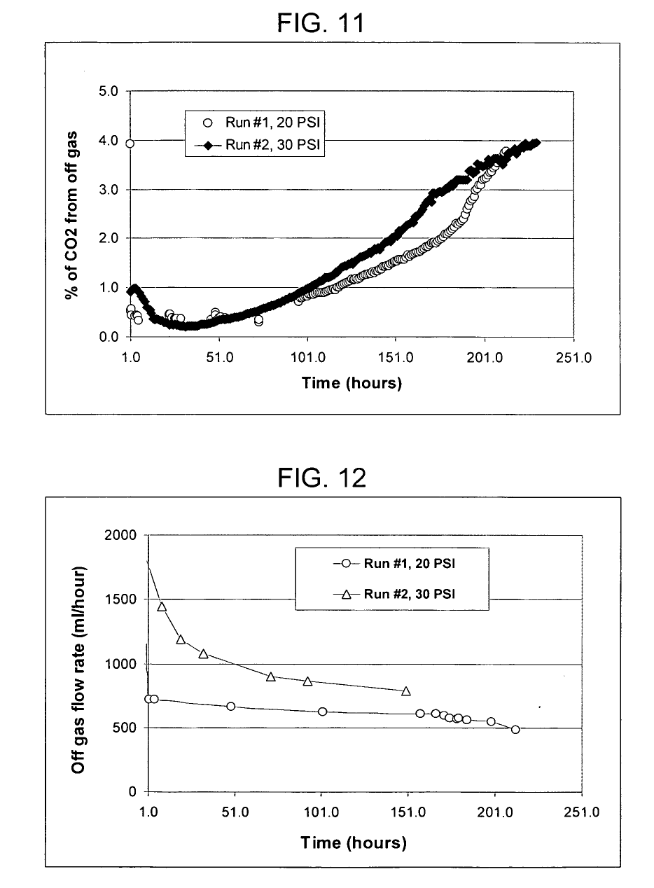

Since Run #1 and Run #2 used the same set of hollow fiber loops 40, a comparison of results for Run #1 and Run #2 was performed in order to evaluate the performance of the hollow fiber loops 40 in Run #2 after washing and drying. The off gas stream CO₂ content and flow rate for Run #1 and Run #2 are plotted in FIG. 10, FIG. 11 and FIG. 12. For both Run #1 and Run #2, a fixed amount of absorption liquid 14 with a total volume of about 750 mL was contained in the cylinder.

Run #1 and Run #2 both continued for longer than 200 hours. For Run #2, the pressure of the gas stream at the gas inlet 20 was 30 psi, as compared with 20 psi in Run #1. With respect to CO₂ absorbing efficiency for Run #1 and Run #2, the first 100 hours were very similar and appear to be independent of the pressure of the gas stream at the gas inlet 20. After 100 hours, the CO₂ contents of the off gas streams for Run #1 and Run #2 began to be distinguishable. Run #2 had a higher feed gas stream pressure and a higher off gas stream flow rate, with the result that the effectiveness of the reactant chemical in the absorption liquid 14 diminished relatively more quickly than for Run #1. As a consequence, the equilibrium of the reaction between the CO₂ may shift and cause a decrease in efficiency of the absorbing reaction. This reaction equilibrium shift could be controlled by circulating the absorption liquid 14 in the cylinder.

It appears from a comparison of the results for Run #1 and Run #2 that the off gas stream flow rate is related to the performance capacity of the hollow fiber loops 40 (i.e., the efficiency of the membrane surface). The observation from both Run #1 and Run #2 is that the off gas flow rate dropped gradually, but that a higher gas stream pressure at the gas inlet 20 provides a higher off gas stream flow rate.

As mentioned, there was no circulation of the absorption liquid 14 in the cylinder during either Run #1 or Run #2. When the running times reached about 150 hours for both Run #1 and Run #2, clear crystals began to appear in the absorption liquid 14. The analysis of these crystals using Raman spectroscopy indicated that the crystals are potassium bicarbonate. The solubility of potassium bicarbonate is much smaller than that of potassium carbonate at room temperature. Therefore the potassium bicarbonate precipitates out for the liquid phase. The growth of these crystals appears to be detrimental to the sparging operation, and may be a cause of the drop in the off gas stream flow rates in both Run #1 and Run #2.

Results and Observation From Run #3:

Run #3 was performed for two different reasons: 1) the total hollow fiber loop 40 length was increased in order to increase the operation capacity; and 2) the absorption liquid 14 in the cylinder was circulated in order to avoid the precipitation of potassium bicarbonate.

The total hollow fiber loop 40 length in Run #3 was about 600 cm. According to fiber dimensions measured from an electronic scanning microscope image the actual total fiber surface area was 23.5 cm². By comparison, the total surface area of the hollow fiber loop 40 set for Run #1 and Run #2 was 8.5 cm². The pressure of the gas stream at the gas inlet 20 was 30 psi during most of Run #3. Both the off gas stream flow rate and the off gas stream CO₂ content were recorded during Run #3. The total running time for Run #3 was 550 hours (23 days).

During Run #3, the absorption liquid 14 in the cylinder was changed three times at hours 143, 243, and 377 respectively. Meanwhile, the absorption liquid 14 drained from the cylinder was collecting to test the potassium carbonate conversion rate using Raman spectroscopic analysis.

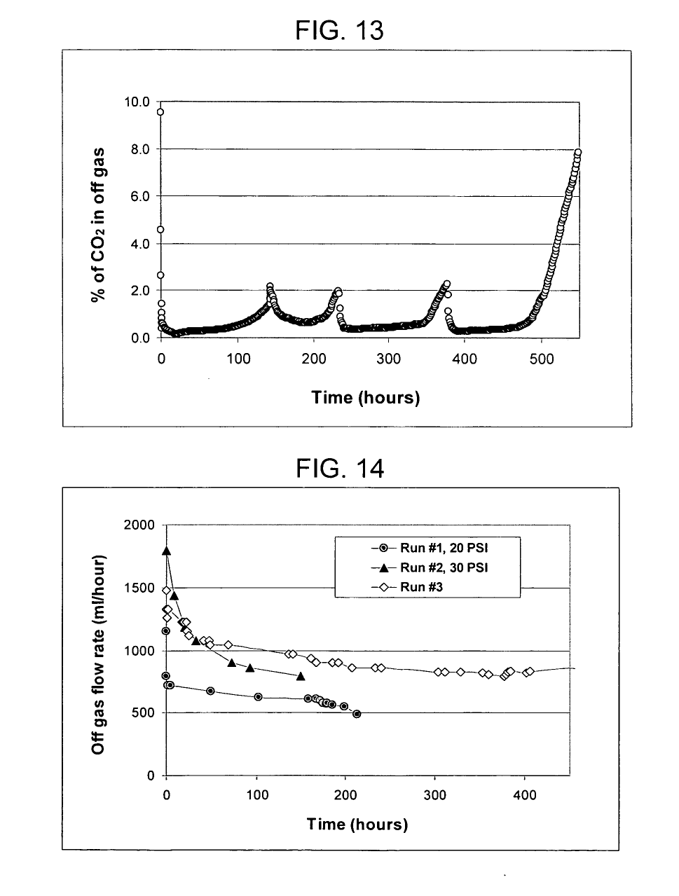

The variation in the amount of CO₂ contained in the off gas stream during Run #3 is depicted in FIG. 13. Significant drops in the amount of CO₂ correspond to the changing of the absorption liquid 14 in the cylinder.

The time and time intervals between changes of the absorption liquid 14 in the cylinder are provided in Table 5. The CO₂ content in the off gas stream at the absorption liquid 14 changing time and the potassium carbonate conversion rate of the drained absorption liquids 14 are also included in Table 5.

TABLE 5
Absorption liquid changing time and potassium carbonate conversion
rate during Run #3

| Solution | | | | | |
|---|---|---|---|---|---|
| changing | #1 | #2 | #3 | #4* | Final train |
| Time intervals | 0-143 | 143-234 | 234-377 | 377-508 | 510-550 |
| (Hours) | | | | | |
| Number of | 143 | 91 | 143 | 131 | 40 |
| Operation | | | | | |
| hours | | | | | |
| Off gas stream | 2.179 | 1.983 | 2.283 | 2.287 | 7.822 |
| CO₂ content | | | | | |
| (%) | | | | | |
| K₂CO₃ | n/a** | 49.5 | 52.5 | n/a** | 73.5 |
| conversion | | | | | |
| Rate (%) | | | | | |

*Note the fourth change of absorption liquid 14 at 508 hours; this point was selected to provide the same CO₂ content in the off gas stream in order to provide a comparison of the number of hours in the time interval for the third change and the fourth change of the absorption liquid 14.
**The first change of absorption liquid 14 at 143 hours was performed by pumping fresh absorption liquid 14 into the cylinder instead of by draining the cylinder.

During Run #3, each time interval between changes of the absorption liquid 14 in the cylinder can be considered as a cycle. Each cycle (except for the second cycle following the first change of the absorption liquid 14) exhibited a similar running time and a similar absorbing efficiency. The shorter running time and slightly lower absorbing efficiency for the second cycle may be attributed to the different manner in which the second change of the absorption liquid 14 was performed. Although there is no potassium carbonate conversion rate data for the first cycle and the fourth cycle, the combination of the CO₂ content in the off gas stream and the off gas stream flow rate could be used to provide an estimate of the potassium carbonate conversion rate.

As mentioned previously, one other purpose for the Run #3 was to try to increase the performance capacity of the apparatus by increasing the total fiber length or the available membrane surface area. The optimization of absorbing efficiency and the off gas stream flow rate can be used as the criteria for overall performance. Therefore, the off gas stream flow rate is one of the most important factors to determine. FIG. 14 provides the off gas stream flow rates from Run #1, Run #2 and Run #3. It is apparent that the off gas stream flow rate is related to the pressure of the gas stream at the gas inlet. The off gas stream flow rate at a gas inlet pressure of 30 psi is higher than the off gas stream flow rate at a gas inlet pressure of 20 psi.

Quick drops in the off gas stream flow rate were observed at the beginning of each of Run #1, Run #2 and Run #3. These quick drops of the off gas stream flow rate may be due to the quick plugging of the very small pores 28 on the fiber wall. Although Run #2 and Run #3 have different lengths of hollow fiber loop 40, the initial drop in off gas stream flow rate are similar for these Runs, possibly due to a similarity in pore size distribution in the fiber wall.

The drops in off gas stream flow rate are much smaller after the initial stage for each of Run #1, Run #2 and Run #3. The total length of hollow fiber loop 40 for Run #3 is almost two times longer than that for Run #2, but the off gas stream flow rate for Run #3 is not doubled. If the hollow fiber loop 40 is too long, pressure drop along the fiber wall may cause additional pore 28 plugging. Therefore, it may advisable to increase the total membrane surface area by increasing the number of hollow fiber loops 40 instead of by increasing the length of the hollow fiber loops 40.

The above described testing of polysulfone hollow fiber loops 40 as a sparger in a gas absorption apparatus 10 provided the following conclusions:

1. Polysulfone hollow fiber loops 40 used as a sparger are effective in inorganic based absorption liquids for a reasonable period of time.
2. Polysulfone hollow fiber loops 40 can be revitalized by washing the loops 40 with water.
3. The absorbing efficiency of a gas absorption apparatus including polysulfone hollow fiber loops 40 as a sparger may average as high as about 99%.
   Selection of Reactant Chemical

Typically, acid gas absorption processes employ an aqueous solution of a salt containing sodium or potassium as the cation with an anion selected so that the resulting solution is buffered at a pH about 9-11. Such a solution, being alkaline in nature, will absorb CO₂ and other acid gases. Salts, which have been proposed for processes of this type, include sodium and potassium carbonates, phosphate, borate, arsenite and phenolate, as well as salts of weak organic acids. Sodium and potassium carbonate solutions have been used extensively for the absorption of CO₂ from gas streams because of their relative low cost and ready availability.

The success of the absorption and desorption of carbon dioxide in a solution of alkali carbonate depends upon the reversibility of the reaction. The reaction equilibrium tends to go towards the right at low temperature and towards the left at higher temperature. Other factors such as high operating pressure, high partial pressure of CO₂, or concentration of the alkali carbonate solution, could also shift the reaction equilibrium to the right.

Very general comparisons are given in Table 6 for an overall evaluation of reactant chemicals. MEA is selected as a representative of amine-based reactant chemicals to compare with other reactant chemicals. In Table 6, the comment of fast and slow, high and low are relative to each other. Overall, potassium carbonate with additives such as a promoter appear to be the best choice. However, other amine-based reactant chemicals such as MEA with a promoter would delivery even better results. The attraction of using aqueous ammonia as a reactant chemical is the by-product, ammonium bicarbonate, which can potentially be used as a fertilizer. For the application of producing CO₂ from flue gas, the regeneration of CO₂ has to incorporate a waterwashing tower to reabsorb the NH₃ in the regeneration cycle.

TABLE 6
General comparison of the processes using different absorbing solutions

| | | | Potassium | |
|---|---|---|---|---|
| Most | | | Carbonate | |
| Concerned | | Potassium | with | Aqueous |
| Aspects | MEA | Carbonate | promoter | Ammonia |
| Absorbing | Fast | Slow | Fast | Fast |
| Reaction time | | | | |
| Solvent make | Yes | No | No | No |
| Up | | | | |
| Regeneration | Low | High | Low | High |
| Energy | | | | |
| Corrosion | High | Low | Low | High |
| Capital cost | Low | High | Low | No data |

The major drawback in a conventional potassium carbonate gas absorbing process is the slow reaction rate. The consequences of the slow reaction rate are the lower carbonate to bicarbonate conversion rate and the higher cost of steam for CO₂ regeneration.

Two advantages of using permeable membranes include: 1) a potentially much higher gas-liquid contact surface area; and 2) more controllable gas phase pressure, liquid phase pressure, and flow rate. These advantages could compensate for the slow absorbing reaction rate associated with potassium carbonate as a reactant chemical. If a higher carbonate to bicarbonate conversion rate can be obtained using permeable membranes, the regeneration energy could also potentially be reduced significantly. The advantages of having little or no solvent degradation and/or oxidation of potassium carbonate will also potentially reduce the operating cost.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

The embodiments of the invention in which an exclusive property or privilege is claimed are defined as follows:

1. A method of treating a gas stream containing an acid gas, comprising: immersing a permeable membrane having a plurality of pores in an absorption liquid containing a reactant chemical, and passing the gas stream through the pores in the permeable membrane so that the gas stream forms gas bubbles which float up through the absorption liquid and so that the acid gas in the gas stream reacts with the reactant chemical in the absorption liquid, thereby separating the acid gas from the gas stream.

2. The method as claimed in claim 1 wherein the permeable membrane is comprised of a hollow membrane defining a permeable conduit and wherein the gas stream is fed into the conduit.

3. The method as claimed in claim 2 wherein the hollow membrane is comprised of at least one loop with two opposed ends, wherein the gas stream is fed into the at least one loop from one of the opposed ends, and wherein the other of the opposed ends is blocked.

4. The method as claimed in claim 2 wherein the hollow membrane is comprised of at least one loop with two opposed ends, and wherein the gas stream is fed into the at least one loop from each of the opposed ends.

5. The method as claimed in claim 2 wherein the hollow membrane is comprised of a module comprising a plurality of loops each with two opposed ends.

6. The method as claimed in claim 1 wherein the acid gas is comprised of carbon dioxide.

7. The method as claimed in claim 1 wherein the acid gas is comprised of hydrogen sulphide.

8. The method as claimed in claim 1 wherein the reactant chemical is comprised of an organic solvent.

9. The method as claimed in claim 1 wherein the reactant chemical is comprised of an inorganic solvent.

10. The method as claimed in claim 1 wherein the reactant chemical is comprised of potassium carbonate.

11. The method as claimed in claim 1, further comprising regenerating the absorption liquid.

12. The method as claimed in claim 1 wherein the pores have a size rating of between about 0.01 micrometers and about 100 micrometers.

13. The method as claimed in claim 12 wherein the pores have a size rating of between about 0.1 micrometers and about 10 micrometers.

14. A method of treating a gas stream containing an acid gas, comprising: immersing a permeable membrane module in an absorption liquid containing an inorganic solvent as a reactant chemical, wherein the permeable membrane module is comprised of a plurality of hollow membrane loops each defining a permeable conduit, wherein each of the hollow membrane loops has a plurality of pores, filling the hollow membrane loops with the gas stream so that the gas stream passes through the pores to form gas bubbles which float up through the absorption liquid and so that the acid gas in the gas stream reacts with the reactant chemical in the absorption liquid, thereby separating the acid gas from the gas stream, and regenerating the reactant chemical.

15. The method as claimed in claim 14 wherein the acid gas is comprised of carbon dioxide.

16. The method as claimed in claim 14 wherein the acid gas is comprised of hydrogen sulphide.

17. The method as claimed in claim 14 wherein the reactant chemical is comprised of potassium carbonate.

18. The method as claimed in claim 14 wherein the pores have a size rating of between about 0.01 micrometers and about 100 micrometers.

19. The method as claimed in claim 18 wherein the pores have a size rating of between about 0.1 micrometers and about 10 micrometers.

20. A method of treating a gas stream containing carbon dioxide, comprising: immersing a permeable membrane module in an absorption liquid containing a reactant chemical comprising an inorganic solvent capable of reacting in a reversible reaction with carbon dioxide, wherein the permeable membrane module is comprised of a plurality of hollow membrane loops each defining a permeable conduit, wherein each of the hollow membrane loops has a plurality of pores, filling the hollow membrane loops with the gas stream so that the gas stream passes through the pores to form gas bubbles which float up through the absorption liquid and so that the carbon dioxide in the gas stream reacts with the reactant chemical in the absorption liquid, thereby separating the carbon dioxide from the gas stream, and regenerating the reactant chemical using a steam regeneration process.

21. The method as claimed in claim 20 wherein the reactant chemical is comprised of potassium carbonate.

22. The method as claimed in claim 20 wherein the hollow membrane loops are comprised of polysulfone fibers.

23. The method as claimed in claim 20 wherein the pores have a size rating of between about 0.01 micrometers and about 100 micrometers.

24. The method as claimed in claim 23 wherein the pores have a size rating of between about 0.1 micrometers and about 10 micrometers.

25. A gas absorption apparatus, comprising:
(a) a housing adapted to hold an absorption liquid containing a reactant chemical, the housing having a gas inlet and a gas outlet; and
(b) a permeable membrane contained within the housing and adapted to be immersed in the absorption liquid, the permeable membrane comprising a plurality of hollow membrane loops connected with the gas inlet, each defining a permeable conduit and each having two opposed ends, each of the hollow membrane loops having a plurality of pores interposed between the gas inlet and the gas outlet.

26. The gas absorption apparatus as claimed in claim 25 wherein the housing has a liquid inlet and a liquid outlet, further comprising means to circulate the absorption liquid into the housing through the liquid inlet and out of the housing through the liquid outlet.

27. The gas absorption apparatus as claimed in claim 26 wherein the liquid outlet and the liquid inlet are connected with a regeneration apparatus such that the absorption liquid is continuously drawn from the liquid outlet into the regeneration apparatus for regeneration and regenerated absorption liquid is returned to the liquid inlet.

28. The gas absorption apparatus as claimed in claim 25 wherein the hollow membrane loops are comprised of polysulfone fibers.

29. The gas absorption apparatus as claimed in claim 25 wherein the pores have a size rating of between about 0.01 micrometers and about 100 micrometers.

30. The gas absorption apparatus as claimed in claim 29 wherein the pores have a size rating of between about 0.1 micrometers and about 10 micrometers.
